(19) United States
(12) Patent Application Publication
(10) Pub. No.: US 2025/0371772 A1
(43) Pub. Date: Dec. 4, 2025

(54) Illumination Rendering in Virtual Environments

(71) Applicant: Tencent Technology (Shenzhen) Company Limited, Shenzhen (CN)

(72) Inventors: Dong Ye, Shenzhen (CN); Yingpeng Zhang, Shenzhen (CN)

(21) Appl. No.: 19/299,397

(22) Filed: Aug. 14, 2025

Related U.S. Application Data
(63) Continuation of application No. PCT/CN2024/103126, filed on Jul. 2, 2024.

(30) Foreign Application Priority Data
Sep. 6, 2023 (CN) 2023111413312

(51) Int. Cl. G06T 11/60; G06T 11/20; G06V 10/60

(52) U.S. Cl. CPC G06T 11/60; G06T 11/20; G06V 10/60

(57) ABSTRACT

Improved illumination rendering techniques are described herein. The techniques include obtaining to-be-rendered virtual scene data; determining a plurality of virtual visible light sources in a virtual scene based on the virtual scene data, determining a screen-to-body ratio of each virtual visible light source, and performing batch rendering drawing on a first virtual visible light source in the plurality of virtual visible light sources, to obtain a first drawing result, the screen-to-body ratio of the first virtual visible light source being less than a preset screen-to-body ratio threshold; determining a light source list of each screen tile, the light source list including a second virtual visible light source whose screen-to-body ratio is greater than or equal to the screen-to-body ratio threshold; and performing full-screen drawing based on the light source list of each screen tile, to obtain a second drawing result, and merging the first drawing result with the second drawing result, to obtain a drawn virtual scene.

### CROSS-REFERENCE TO RELATED APPLICATIONS

This application is a Continuation of PCT Application No. PCT/CN2024/103126, filed Jul. 2, 2024, and further claims priority to Chinese Patent Application No. 2023111413312, filed Sep. 6, 2023, each entitled “Rendering Method and Apparatus, Electronic Device, Computer-Readable Storage Medium, and Computer Program Product” and each of which is incorporated by reference in its entirety.

### FIELD

This application relates to image processing technologies, and in particular, to a rendering method and apparatus, an electronic device, a computer-readable storage medium, and a computer program product.

### BACKGROUND

With continuous development of image processing technologies, a user has increasingly higher requirements on image quality. In many large virtual scenes, there are a large quantity of light sources, and each light source has a different degree of impact on each virtual model in the large virtual scenes. Therefore, to improve sense of reality of a virtual scene, illumination rendering of a plurality of light sources has become a key point in image processing.

In the related art, when the illumination rendering of the plurality of light sources is performed, a tile-based lighting algorithm and a cluster-based lighting algorithm are usually used. Division into a plurality of screen tiles is needed for both the tile-based lighting algorithm and the cluster-based lighting algorithm, and each screen tile maintains a light source list. Updating the light source list of each screen tile in a scene with a large quantity of light sources is quite a time-consuming task, and consequently, a rendering frame rate is significantly reduced.

### SUMMARY

Aspects described herein provide a rendering method and apparatus, an electronic device, a computer-readable storage medium, and a computer program product, which can improve rendering efficiency.

Technical solutions of the aspects described herein are implemented as follows.

An aspect described herein provides a rendering method, applied to an electronic device, and including:
obtaining to-be-rendered virtual scene data, determining a plurality of virtual visible light sources in a virtual scene based on the virtual scene data, and determining a screen-to-body ratio of each virtual visible light source;
performing batch rendering drawing on a first virtual visible light source in the plurality of virtual visible light sources, to obtain a first drawing result, the screen-to-body ratio of the first virtual visible light source being less than a preset screen-to-body ratio threshold;
determining a light source list of each screen tile, the light source list including a second virtual visible light source whose screen-to-body ratio is greater than or equal to the screen-to-body ratio threshold;
performing full-screen drawing based on the light source list of each screen tile, to obtain a second drawing result; and
merging the first drawing result with the second drawing result, to obtain a drawn virtual scene, and displaying the virtual scene.

An aspect described herein provides a rendering apparatus, including:
a first determining module, configured to: obtain to-be-rendered virtual scene data, determine a plurality of virtual visible light sources in a virtual scene based on the virtual scene data, and determine a screen-to-body ratio of each virtual visible light source;
a first rendering module, configured to perform batch rendering drawing on a first virtual visible light source in the plurality of virtual visible light sources, to obtain a first drawing result, the screen-to-body ratio of the first virtual visible light source being less than a preset screen-to-body ratio threshold;
a second determining module, configured to determine a light source list of each screen tile, the light source list including a second virtual visible light source whose screen-to-body ratio is greater than or equal to the screen-to-body ratio threshold;
a second rendering module, configured to perform full-screen drawing based on the light source list of each screen tile, to obtain a second drawing result; and
a display module, configured to: merge the first drawing result with the second drawing result, to obtain a drawn virtual scene, and display the virtual scene.

An aspect described herein provides an electronic device, including:
a memory, configured to store computer-executable instructions; and
a processor, configured to implement the rendering method according to the aspects described herein when executing the computer-executable instructions stored in the memory.

An aspect described herein provides a computer-readable storage medium, having a computer program or computer-executable instructions stored therein, the computer program or the computer-executable instructions being configured to implement, when executed by a processor, the rendering method according to the aspects described herein.

An aspect described herein provides a computer program product, including a computer program or computer-executable instructions, the computer program or the computer-executable instructions, when executed by a processor, implementing the rendering method according to the aspects described herein.

The aspects described herein have the following beneficial effects.

After the to-be-rendered virtual scene data is obtained, the plurality of virtual visible light sources in the virtual scene is first determined based on the virtual scene data, to ensure that only the visible light sources are rendered subsequently, thereby reducing a data amount and complexity of rendering processing. The screen-to-body ratio of each virtual visible light source is determined, and then for the first virtual visible light sources whose screen-to-body ratio is less than the preset screen-to-body ratio threshold, batch drawing is performed on a plurality of first virtual visible light sources by invoking a batch rendering drawing command. For the second virtual visible light source whose screen-to-body ratio is greater than or equal to the screen-to-body ratio threshold, the light source list of each screen tile is determined, and the light source list includes only the second virtual visible light source, and then the full-screen drawing is performed based on the light source list of each screen tile, to obtain a rendered virtual scene. In other words, in the aspects described herein, a solution of combining batch drawing and tile-based rendering is used. First, the batch drawing command is invoked once to complete drawing of all of a large quantity of light sources whose screen-to-body ratios are less than the screen-to-body ratio threshold, thereby greatly reducing a calculation amount of tile-based rendering while improving rendering efficiency. Then, for the second virtual visible light source whose screen-to-body ratio is greater than the screen-to-body ratio threshold, the tile-based rendering is performed, that is, parallel rendering is performed on second virtual visible light sources in a plurality of screen tiles, which not only can ensure a rendering effect on the second virtual visible light sources, but also can rapidly render the large quantity of light sources in the virtual scene, thereby improving the rendering efficiency.

### BRIEF DESCRIPTION OF THE DRAWINGS

FIG. 1 is a schematic diagram of a network architecture of a rendering system 100 according to an aspect described herein.

FIG. 2 is a schematic structural diagram of a terminal 400 according to an aspect described herein.

FIG. 3A is a schematic flowchart of an implementation of a rendering method according to an aspect described herein.

FIG. 3B is a schematic flowchart of an implementation of determining a virtual visible light source and a screen-to-body ratio of the virtual visible light source according to an aspect described herein.

FIG. 4A is a schematic flowchart of an implementation of performing batch rendering drawing on a first virtual visible light source according to an aspect described herein.

FIG. 4B is a schematic flowchart of an implementation of determining a light source list of each screen tile according to an aspect described herein.

FIG. 4C is a schematic diagram of a light source node in a light source list according to an aspect described herein.

FIG. 5 is a schematic flowchart of an implementation of performing full-screen drawing based on a light source list according to an aspect described herein.

FIG. 6A is a schematic flowchart of an implementation of performing compressed storage on a light source list according to an aspect described herein.

FIG. 6B is another schematic diagram of performing compressed storage on a light source list according to an aspect described herein.

FIG. 7A is a light effect diagram of a city night view from an airplane according to an aspect described herein.

FIG. 7B is a dynamic light and shadow effect diagram of a vehicle traveling on a road according to an aspect described herein.

FIG. 7C is a night-scene light effect diagram of a digital Great Wall according to an aspect described herein.

FIG. 8 is a schematic flowchart of another implementation of a rendering method according to an aspect described herein.

FIG. 9 is a schematic diagram of an effect of performing long-distance light source rendering and short-distance light source rendering by using a rendering method according to an aspect described herein.

FIG. 10 is a diagram of a comparison effect between a rendering method according to an aspect described herein and a cluster-based lighting algorithm in the related art.

### DETAILED DESCRIPTION

To make the objectives, technical solutions, and advantages described herein clearer, the following further describes this application in detail with reference to the accompanying drawings. The described aspects are not to be considered as a limitation to this application. All other aspects obtained by a person of ordinary skill in the art without creative efforts shall fall within the protection scope described herein.

In the following descriptions, related “some aspects” describe a subset of all possible aspects. However, the “some aspects” may be the same subset or different subsets of all the possible aspects, and may be combined with each other without conflict.

In the following descriptions, the term “first/second” involved is merely used for distinguishing between similar objects and does not represent a specific order of objects. “First/second” may be interchanged in a specific order or a sequence when allowed, so that the aspects described herein described herein can be implemented in an order other than those illustrated or described herein.

In the aspects described herein, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including the module or unit function.

Unless otherwise defined, meanings of all technical and scientific terms used in the aspects described herein are the same as those usually understood by a person skilled in the relevant technical field. Terms used in the aspects described herein are merely intended to describe the objectives of the aspects described herein, and are not intended to limit this application.

Before the aspects described herein are further described in detail, terms involved in the aspects described herein are described. The terms involved in the aspects described herein are applicable to the following explanations.
(1) A point light source refers to a light source that uniformly emits light from a point to a surrounding space.
(2) A parallel light source refers to a light source that emits parallel and non-divergent light.
(3) A spotlight light source is a centered light source, and has a cone shape. A farther distance from the light source indicates a larger circular region to be illuminated.
(4) Batch rendering drawing generally refers to a manner of combining a plurality of rendering tasks together. In this aspect described herein, performing batch rendering drawing on a plurality of virtual light sources is combining the plurality of virtual light sources together for rendering, to improve rendering efficiency.
(5) Full-screen drawing refers to drawing all screen tiles of an entire screen one time.
(6) Frustum culling is a space culling technology, and determines whether an object is visible based on a camera frustum. The camera frustum is a geometrical representation of a field of view of a camera. The camera frustum is formed by six planes, and determines a space region that can be seen by the camera. During rendering of each frame, a system checks whether all objects are completely located in the camera frustum of the camera or intersect with the camera frustum of the camera. If the object is not in the camera frustum, the object is culled. The frustum culling cannot cull objects that are located in the camera frustum but are occluded by another item.
(7) Occlusion culling is a more advanced space culling technology, and determines whether to render by detecting whether an object is occluded by another item. Specifically, the occlusion culling calculates an occlusion relationship of an object in a scene in advance, constructs a data structure to indicate a visible object at a current camera viewing angle, and culls an invisible object.
(8) A light source attenuation coefficient is a parameter that describes a decrease in light source intensity as a distance increases. The light source attenuation coefficient reflects a feature that light intensity gradually decreases as a distance increases in a propagation process. An attenuation coefficient is usually configured for calculating illumination intensity of a light source at different distances, so as to consider an attenuation effect of the light source when designing a lighting system or performing illumination simulation.

To better understand the rendering method provided in the aspects described herein, a tile-based lighting algorithm and a cluster-based lighting algorithm for multi-light source rendering in the related art and their shortcomings are first described.

During implementation of the tile-based lighting algorithm, two-dimensional (2D) partitioning is first performed on a screen space in real time, then a light source list affecting each tile is calculated, and finally, illumination rendering is performed pixel by pixel according to the light source list obtained based on the tile to which the pixel belongs.

During implementation of the cluster-based lighting algorithm, three-dimensional (3D) partitioning is first performed on a screen space in real time, then a light source list affecting each tile is calculated, and finally, illumination rendering is performed pixel by pixel according to the light source list obtained based on the tile to which the pixel belongs.

In the tile-based lighting algorithm and the cluster-based lighting algorithm, during illumination rendering, a G-buffer is read only once and a color buffer is written to once. This is independent of a quantity of light sources, and bandwidth consumption can be greatly reduced. The quantity of light sources on the same screen can be increased to several thousands. However, in a scene with a large quantity of light sources, updating the light source list of each tile is also quite a time-consuming task. When the quantity of light sources in the scene reaches ten thousands or even one hundred thousands, a frame rate is significantly reduced.

The aspects described herein provide a rendering method and apparatus, an electronic device, a computer-readable storage medium, and a computer program product, which can improve rendering efficiency. An illustrative application of the electronic device provided in the aspects described herein is described below. The electronic device provided in the aspects described herein may be implemented as various types of user terminals such as a notebook computer, a tablet computer, a desktop computer, a set-top box, a mobile device (for example, a mobile phone, a portable music player, a personal digital assistant, a dedicated messaging device, or a portable game device), a smartphone, a smart speaker, a smartwatch, a smart television, or an in-vehicle terminal. An illustrative application in which a device is implemented as a terminal is described below.

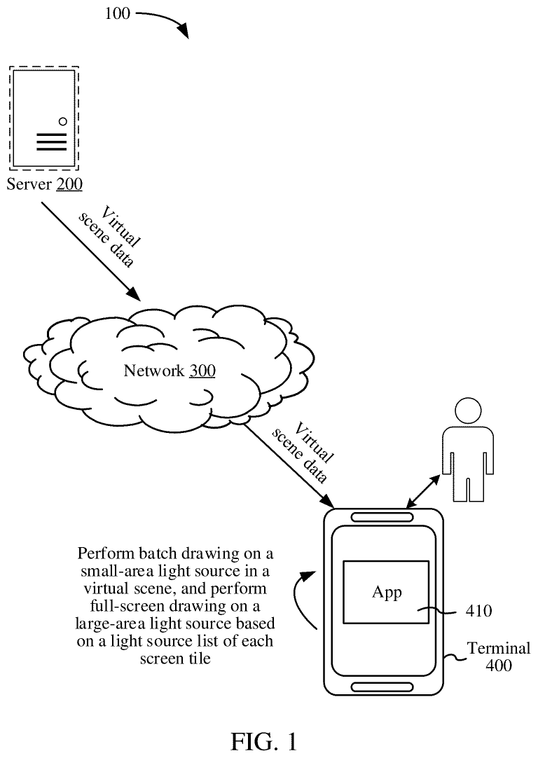

Refer to FIG. 1. FIG. 1 is a schematic diagram of a network architecture of a rendering system 100 according to an aspect described herein. As shown in FIG. 1, the rendering system 100 includes a server 200, a network 300, and a terminal 400, and the terminal 400 is connected to the server 200 through the network 300. The network 300 may be a wide area network, a local area network, or a combination thereof.

The terminal 400 is configured to obtain virtual scene data from the server 200. The virtual scene data may be virtual scene data in a game application, virtual scene data of virtual reality, or virtual scene data of augmented reality. The terminal 400 stores the virtual scene data into a local storage space, then the terminal 400 determines a plurality of virtual visible light sources in a virtual scene based on the virtual scene data, and determines a screen-to-body ratio of each virtual visible light source. Then, for a first virtual visible light source whose screen-to-body ratio is less than a preset screen-to-body ratio threshold, batch drawing is performed on a plurality of first virtual visible light sources by invoking a batch rendering drawing command, to obtain a first drawing result. For a second virtual visible light source whose screen-to-body ratio is greater than or equal to the screen-to-body ratio threshold, a light source list of each screen tile is determined, the light source list includes only the second virtual visible light source, and then full-screen drawing is performed based on the light source list of each screen tile, to obtain a second drawing result. The first drawing result is merged with the second drawing result, to obtain a rendered virtual scene, and the rendered virtual scene is displayed on a graphical interface 410. When rendering the virtual scene, the terminal uses a solution of combining the batch drawing and tile-based rendering. The terminal invokes a batch drawing command once to complete drawing of all of a large quantity of light sources whose screen-to-body ratios are less than the screen-to-body ratio threshold. Therefore, a calculation amount of the tile-based rendering is greatly reduced, so that the large quantity of light sources in the virtual scene can be rapidly rendered, thereby improving rendering efficiency.

In some aspects, the server 200 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, a notebook computer, a desktop computer, a smart speaker, a smartwatch, an in-vehicle terminal, or the like, but is not limited thereto. The terminal may be connected directly or indirectly to the server in a wired or wireless communication manner. This is not limited in this aspect described herein.

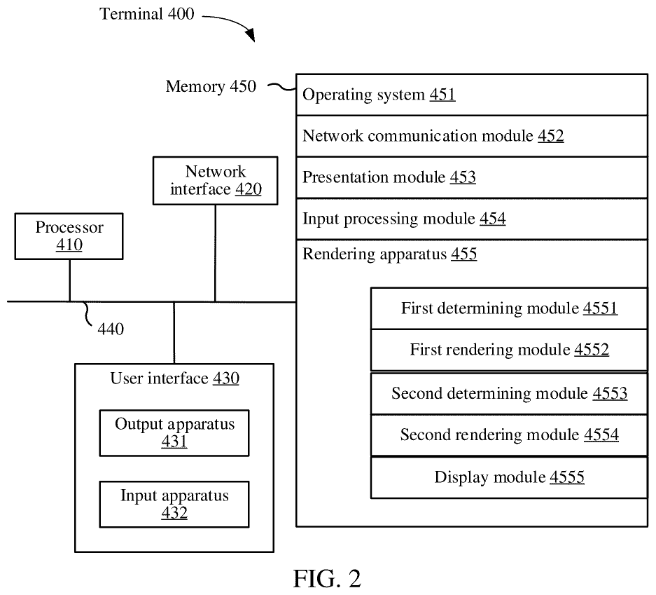

Refer to FIG. 2. FIG. 2 is a schematic structural diagram of a terminal 400 according to an aspect described herein. The terminal 400 shown in FIG. 2 includes: at least one processor 410, a memory 450, at least one network interface 420, and a user interface 430. Components in the terminal 400 are coupled together through a bus system 440. The bus system 440 is configured to implement connection and communication between the components. In addition to a data bus, the bus system 440 further includes a power supply bus, a control bus, and a status signal bus. However, for clarity, various buses are marked as the bus system 440 in FIG. 2.

The processor 410 may be an integrated circuit chip having a signal processing capability, such as a general-purpose processor, a digital signal processor (DSP), or another programmable logic device, a discrete gate or transistor logic device, or a discrete hardware component. The general-purpose processor may be a microprocessor, any conventional processor, or the like.

The user interface 430 includes one or more output apparatuses 431 that can present medium content, including one or more speakers and/or one or more visual display screens. The user interface 430 further includes one or more input apparatuses 432, including user interface members that facilitate a user input, such as a keyboard, a mouse, a microphone, a touch display screen, a camera, and another input button and control.

The memory 450 may be a removable memory, an irremovable memory, or a combination thereof. An illustrative hardware device includes a solid memory, a hard disk drive, an optical disk drive, and the like. In some aspects, the memory 450 includes one or more storage devices that are physically away from the processor 410.

The memory 450 includes a volatile memory or a non-volatile memory, or may include both the volatile memory and the non-volatile memory. The non-volatile memory may be a read-only memory (ROM), and the volatile memory may be a random access memory (RAM). The memory 450 described in this aspect described herein aims to include any suitable type of memory.

In some aspects, the memory 450 can store data to support various operations. Examples of the data include a program, a module, a data structure, or a subset or a superset thereof, which are described below by using an example.

An operating system 451 includes system programs configured to process various basic system services and perform hardware-related tasks, for example, a frame layer, a core library layer, and a driver layer, which are configured to implement various basic businesses and process hardware-based tasks.

A network communication module 452 is configured to reach another electronic device through one or more (wired or wireless) network interfaces 420. For example, the network interface 420 includes a Bluetooth, wireless compatibility authentication (Wi-Fi), and a universal serial bus (USB).

A presentation module 453 is configured to present information through one or more output apparatuses 431 (for example, a display screen or a speaker) associated with the user interface 430 (for example, a user interface for operating a peripheral device and displaying content and information).

An input processing module 454 is configured to detect one or more user inputs or interactions from one or more input apparatuses 432 and translate the detected inputs or interactions.

In some aspects, an apparatus provided in the aspects described herein may be implemented by using software. FIG. 2 shows a rendering apparatus 455 that is stored in the memory 450. The rendering apparatus may be software in a form of a program, a plug-in, and the like, including the following software modules: a first determining module 4551, a first rendering module 4552, a second determining module 4553, a second rendering module 4554, and a display module 4555. These modules are logical, and therefore, can be combined or further split in different manners depending on implemented functions. The functions of the modules are to be described below.

In some other aspects, the apparatus provided in the aspects described herein may be implemented by using hardware. As an example, the apparatus provided in the aspects described herein may be a processor in the form of a hardware decoding processor, programmed to perform the rendering method provided in the aspects described herein. For example, the processor in the form of the hardware decoding processor may use one or more application specific integrated circuits (ASIC), a digital signal processor (DSP), a programmable logic device (PLD), a complex programmable logic device (CPLD), a field-programmable gate array (FPGA), or other electronic components.

The rendering method provided in the aspects described herein is described with reference to the illustrative applications and implementations of the terminal provided in the aspects described herein.

The following describes the rendering method provided in the aspects described herein. As mentioned above, the electronic device that implements the rendering method provided in the aspects described herein may be a terminal. Therefore, an execution body of each operation is not repeatedly described below.

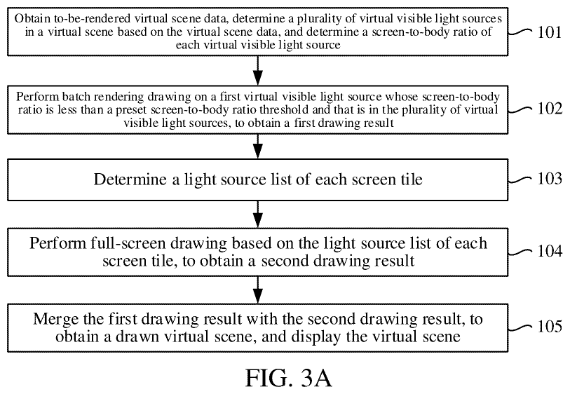

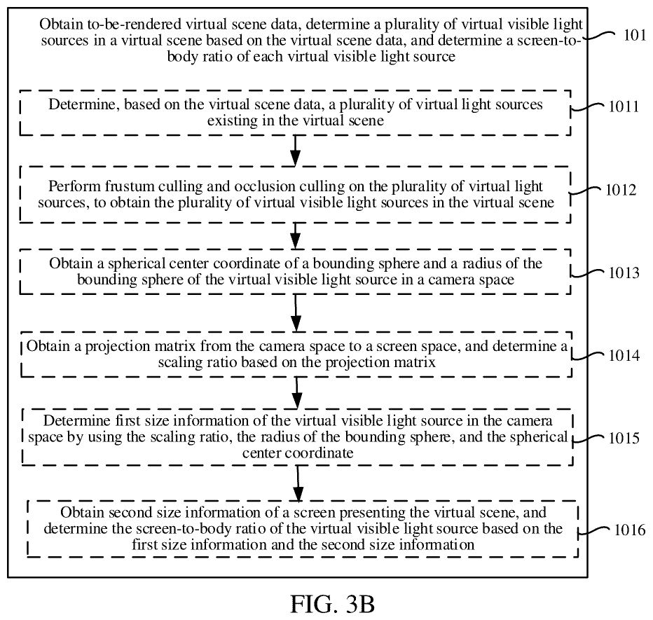

Refer to FIG. 3A. FIG. 3A is a schematic flowchart of an implementation of a rendering method according to an aspect described herein. Descriptions are provided with reference to operations shown in FIG. 3A. An execution body of the operations shown in FIG. 3A is a terminal.

In operation 101, to-be-rendered virtual scene data is obtained, a plurality of virtual visible light sources in a virtual scene are determined based on the virtual scene data, and a screen-to-body ratio of each virtual visible light source is determined.

In some aspects, the to-be-rendered virtual scene data may be virtual scene data in a game application, virtual scene data of virtual reality, or virtual scene data of augmented reality. Refer to FIG. 3B. Operation 101 may be implemented by the following operations 1011 to 1016. Descriptions are provided below with reference to FIG. 3B.

In operation 1011, a plurality of virtual light sources existing in the virtual scene are determined based on the virtual scene data.

In some aspects, the virtual scene data includes an object identifier of each virtual object existing in the virtual scene, and position information of each virtual object. The virtual object in the virtual scene includes an immovable object, for example, may be a virtual building or a virtual tree, and may further include a movable object, for example, a virtual monster or a virtual vehicle. The virtual object may alternatively be a virtual light source, for example, may be a fixed virtual street lamp, or various virtual lamps in a virtual building, or may be a headlamp or a flashlight worn on a virtual person, or may be a car lamp of a virtual car. The object identifier of the virtual object can represent a type and a number of the virtual object. For example, when the virtual object is a virtual building, the object identifier of the virtual object may be building_1, building_2, or the like; when the virtual object is a virtual tree, the object identifier may be tree_1 or tree_2; and when the virtual object is a virtual light source, the object identifier may be light_1, light_2, or the like. During implementation of operation 1011, the type of the virtual object may be determined from the virtual scene data based on the object identifier of the virtual object, and then the plurality of virtual light sources existing in the virtual scene may be determined based on the type of the virtual object. In this aspect described herein, the virtual scene may include a large quantity of virtual light sources of different types, for example, which may include a point light source, a centered light source (a spotlight), a planar light source, and the like.

In operation 1012, frustum culling and occlusion culling are performed on the plurality of virtual light sources, to obtain the plurality of virtual visible light sources in the virtual scene.

Because a visible range of a camera in a three-dimensional scene is presented as a camera frustum, and the camera frustum is similar to a frustum, when an item in the three-dimensional space is located inside six faces of the camera frustum or intersects with any one of the six faces of the camera frustum, it indicates that the item is visible. On the contrary, when an item in the three-dimensional space is not located inside the six faces of the camera frustum and does not intersect with any one of the six faces of the camera frustum, the item is invisible. A larger quantity of times that a computer performs drawing for rendering of a three-dimensional scene per second indicates a more coherent rendered virtual scene. Therefore, reducing a data amount of drawing in each frame is a key to accelerating three-dimensional scene rendering in computer graphics. Therefore, frustum culling and occlusion culling need to be performed on the plurality of virtual light sources in the virtual scene.

When the frustum culling is performed on the plurality of virtual light sources, a bounding body of each virtual light source may be first determined. The bounding body may be a bounding sphere, an axis-aligned bounding box (AABB), or an oriented bounding box (OBB). Then, whether the bounding body of each virtual light source is inside the camera frustum or intersects with any face of the camera frustum is determined. If a bounding body of a virtual light source is inside the camera frustum or intersects with any face of the camera frustum, it is determined that the virtual light source is within a visual range of the camera frustum, and the virtual light source is not culled; or if a bounding body of a virtual light source is not inside the camera frustum and does not intersect with any face of the camera frustum, it is determined that the virtual light source is not within a visible range of the camera frustum, and the virtual light source is culled.

The frustum culling merely does not render a virtual light source outside a viewing angle range of the camera, and a virtual light source that is occluded by another item but is still within the viewing angle range is not culled. It is clear that, the virtual light source occluded by the another item does not need to be rendered. Therefore, after the frustum culling is performed on the plurality of virtual light sources, the virtual light source occluded by the another item may be further culled through the occlusion culling, thereby further reducing a rendering processing amount. During the occlusion culling, an entire depth map of the virtual scene may be drawn in a software rasterization manner, to obtain a depth of each virtual object in the virtual scene, and then an occlusion relationship between different virtual objects is determined by using a depth relationship between the different virtual objects, to cull an occluded virtual light source.

In operation 1013, a spherical center coordinate of a bounding sphere and a radius of the bounding sphere of the virtual visible light source in a camera space are obtained.

In some aspects, vertex coordinates of vertexes of all elements in a basic geometrical element set forming the virtual visible light source in the camera space are first obtained. Each virtual object forming the virtual scene may be triangulated to obtain a plurality of triangular patches. Therefore, a basic geometrical element forming a virtual object may be understood as the triangular patch. Therefore, in other words, vertex coordinates of vertexes of the triangular patches forming the virtual visible light source in the camera space are obtained herein. Then, the spherical center coordinate of the bounding sphere of the virtual visible light source is determined based on an average value of the vertex coordinates of all the elements in the camera space, where the bounding sphere of the virtual visible light source is a smallest sphere that can contain the virtual visible light source, then a distance between a spherical center of the bounding sphere and each vertex is determined based on the spherical center coordinate of the bounding sphere and the vertex coordinates of the vertexes of the elements, and a largest distance is determined as the radius of the bounding sphere.

In some aspects, when the vertex coordinates of the vertexes of all the elements in the camera space are determined, absolute position coordinates of all original vertexes in the basic geometry element set forming the virtual visible light source in a world space are first obtained. The world space is a world coordinate system, and refers to an absolute coordinate system of a three-dimensional scene. The elements such as a camera determine positions of the elements according to the coordinate system. The camera space is a camera coordinate system, and refers to a camera coordinate system that is independent of the world coordinate system and that is formed by using a position of the camera as an origin, using an opposite direction of a line-of-sight direction as a Z-axis positive direction, and using an axis in which an upward direction of the camera is located as a Y-axis positive direction. Then, a rotation matrix and a translation matrix from the world space to the camera space and the absolute position coordinates of the vertexes are used to determine the vertex coordinates of the vertexes in the camera space.

In operation 1014, a projection matrix from the camera space to a screen space is obtained, and a scaling ratio is determined based on the projection matrix.

Conversion from the camera coordinate system to a pixel coordinate system is projection transformation. The projection matrix from the camera space to a pixel space (that is, the screen space) is determined according to an intrinsic parameter and an extrinsic parameter of the camera. The intrinsic parameter of the camera refers to a parameter related to a characteristic of the camera, such as a field-of-view angle, a focal length, and resolution of the camera, and an aspect ratio of a camera screen; and the extrinsic parameter of the camera is a pose parameter of the camera in the world coordinate system, for example, a position or a rotation direction of the camera. Further, the projection matrix may be obtained by multiplying an intrinsic parameter matrix and an extrinsic parameter matrix of the camera. In some aspects, the projection matrix may alternatively be determined by using a preset projection matrix calculation function. The scaling ratio is a scaling ratio of a size of the virtual visible light source in the camera space and a size of the virtual visible light source in the screen space. During implementation of determining the scaling ratio based on the projection matrix, an element proj_m[00] in the first row and the first column and an element proj_m[11] in the second row and the second column in the projection matrix may be first obtained, where the element proj_m[00] represents a value obtained by dividing the aspect ratio of the camera screen by a tangent value of

$$\frac{field of view}{2} ,$$

and the element proj_m[11] represents a reciprocal of the tangent value of

$$\frac{field of view}{2} .$$

A product of a larger value of proj_m[00] and proj_m[11] and a preset first weight value is determined as the scaling ratio, and the first weight value is a rational number between 0 and 1, for example, may be 0.5.

The larger value of proj_m[00] and proj_m[11] is selected because the scaling ratio determined by using the larger value is more conservative and more accurate than the scaling ratio determined by using a smaller value of the two.

In operation 1015, first size information of the virtual visible light source in the camera space is determined by using the scaling ratio, the radius of the bounding sphere, and the spherical center coordinate.

In some aspects, a product of the scaling ratio and the radius of the bounding sphere is first determined as a scaling radius, and then a distance between the spherical center of the bounding sphere and an origin is determined according to the spherical center coordinate of the bounding sphere. A reciprocal of the distance is determined as a second weight value if the distance is greater than 1, or the second weight value is determined as 1 if the distance is less than or equal to 1. A product of the second weight value and the scaling radius is determined as the first size information of the virtual visible light source in the camera space. The first size information may be a radius of the virtual visible light source.

For example, if the distance between the spherical center of the bounding sphere and the origin is 2, and the scaling radius is 3, the second weight value is 0.5, and the first size information of the virtual visible light source in the camera space is 0.5*3, that is, 1.5.

In operation 1016, second size information of a screen presenting the virtual scene is obtained, and the screen-to-body ratio of the virtual visible light source is determined based on the first size information and the second size information.

In some aspects, the second size information of the screen may include a screen length and a screen width, a product of the screen length and the screen width may be determined as a screen area, and the first size information of the virtual visible light source in the camera space may be the radius of the virtual visible light source, so that an area of the virtual visible light source may be determined based on an area formula of a circle, and the area of the virtual visible light source is divided by the screen area, to obtain the screen-to-body ratio of the virtual visible light source. The screen-to-body ratio of the virtual visible light source is a ratio of the area of the virtual visible light source to the screen area. The screen-to-body ratio of the virtual visible light source is a real number between 0 and 1. For example, the screen-to-body ratio of the virtual visible light source may be 0.02.

According to the foregoing operations 1011 to 1016, the virtual visible light source in the virtual scene is first obtained through the frustum culling and the occlusion culling. In this way, a quantity of rendering the light sources can be reduced and rendering efficiency can be improved while reality of the rendered virtual scene can be ensured. Then, the screen-to-body ratio of each virtual visible light source is determined, to provide a necessary data basis for rendering light sources with different screen-to-body ratios in different rendering manners.

Still refer to FIG. 3A. The following is described continuing with operation 101.

In operation 102, batch rendering drawing is performed on a first virtual visible light source in the plurality of virtual visible light sources, to obtain a first drawing result.

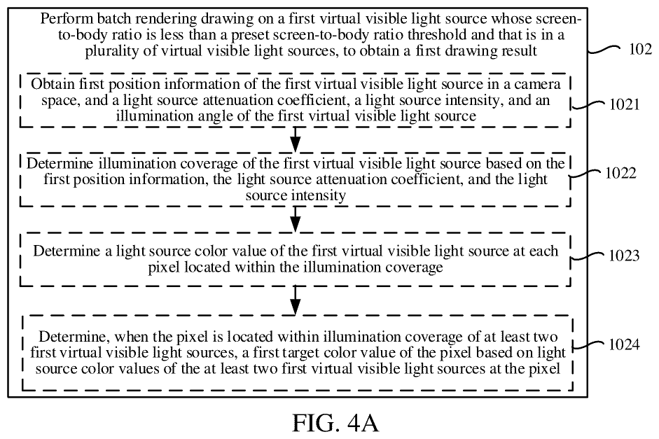

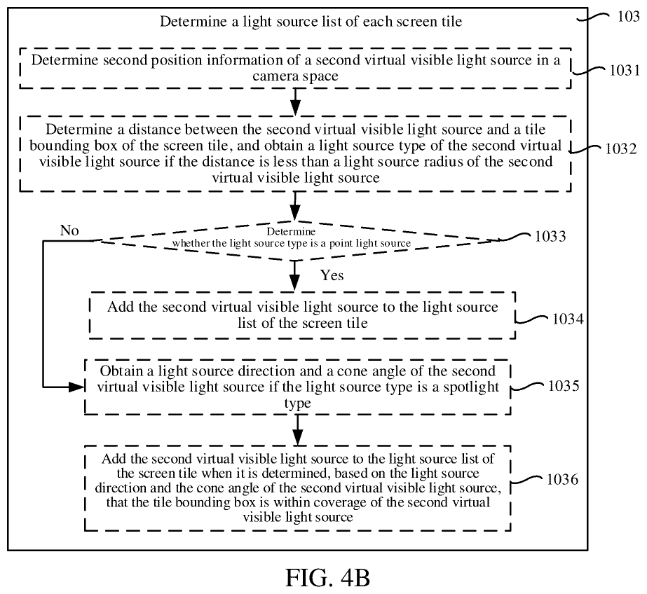

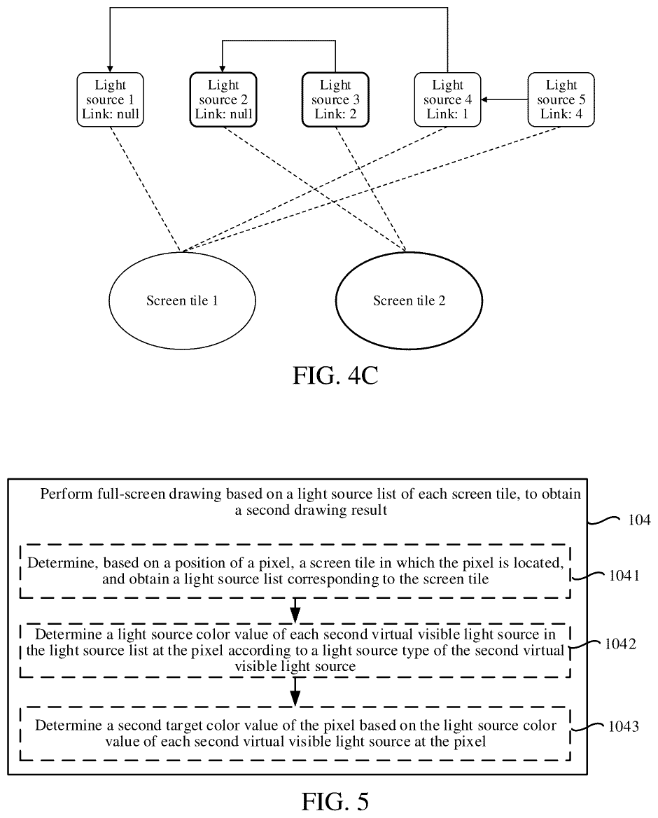

The screen-to-body ratio of the first virtual visible light source is less than a preset screen-to-body ratio threshold, and the screen-to-body ratio threshold is a real number between 0 to 1. For example, the screen-to-body ratio threshold may be 0.05, and the first virtual visible light source whose screen-to-body ratio is less than the preset screen-to-body ratio threshold may be understood as a remote virtual light source having a small area. The batch rendering drawing is performed on the first virtual visible light source whose screen-to-body ratio is less than the screen-to-body ratio threshold, that is, a plurality of first virtual visible light sources are combined to be rendered. This can reduce a rendering quantity and a rendering time, thereby improving the rendering efficiency. In some aspects, refer to FIG. 4A. Operation 102 may be implemented by the following operations 1021 to 1024. Descriptions are provided below with reference to FIG. 4A.

In operation 1021, first position information of the first virtual visible light source in the camera space, a light source attenuation coefficient, a light source intensity, and an illumination angle of the first virtual visible light source are obtained.

In some aspects, the first position information of the first virtual visible light source in the camera space is obtained by performing rigid transformation on a first absolute position of the first virtual visible light source in the world space, the light source attenuation coefficient, the light source intensity, and the illumination angle of the first virtual visible light source are obtained from a preset light source information table based on a light source identity (ID) of the first virtual visible light source after the light source ID is obtained from the virtual scene data, and the light source information table stores information such as a light source type, a light source attenuation coefficient, a light source intensity, an illumination angle, and a color value that correspond to each light source ID.

In operation 1022, illumination coverage of the first virtual visible light source is determined based on the first position information, the light source attenuation coefficient, and the light source intensity.

Because an illumination intensity is attenuated as a distance from the light source increases, the illumination intensity at a position far away from the light source becomes weaker. In some aspects, when an illumination intensity at a position is attenuated to 0, it indicates that the position is not within coverage of the light source. During determining of the illumination coverage of the first virtual visible light source, an attenuation formula corresponding to the first virtual visible light source is first obtained, then a distance between a position at which the illumination intensity is attenuated to 0 or is attenuated to a preset attenuation value (a value close to 0) and the first virtual visible light source is determined by using the attenuation formula, and the illumination coverage of the first virtual visible light source is determined based on the calculated distance, and the light source type and the first position information of the first virtual visible light source. When the illumination coverage of the first virtual visible light source is determined based on the calculated distance, the light source type and the first position information of the first virtual visible light source, if the light source type of the first virtual visible light source is a point light source, the illumination coverage of the first virtual visible light source is a circle using the first position information of the first virtual visible light source as a circle center and using the distance as a radius; and if the light source type of the first virtual visible light source is a spotlight, the illumination angle of the first virtual visible light source further needs to be obtained. The illumination coverage of the first virtual visible light source is a sector using the first position information of the first virtual visible light source as a circle center and using the distance as a radius, and a position of the sector is determined by the illumination angle.

For example, it is assumed that the light source type of the first virtual visible light source is a point light source, and formula (1) is an attenuation formula corresponding to the first virtual visible light source:

$${I}^{′} = I * {e}^{- μ d} , \qquad ( 1 )$$

where I is a light source intensity, μ is a light source attenuation coefficient, and d is a distance from the first virtual visible light source. The distance between the position at which the light source intensity is attenuated to the preset attenuation value and the first virtual visible light source may be determined by using the attenuation formula, and then a circular region using the first position information of the first virtual visible light source as a circle center and using the distance as a radius is determined as the illumination coverage of the first virtual visible light source.

In operation 1023, a light source color value of the first virtual visible light source at each pixel located within the illumination coverage is determined.

In some aspects, a distance between the first virtual visible light source and each pixel within the illumination coverage is first determined, then an illumination intensity value of each pixel is determined by using the attenuation formula (that is, formula (1)) corresponding to the first virtual visible light source, a color value of the first virtual visible light source is obtained, and the color value of the first virtual visible light source is multiplied by the illumination intensity value of each pixel, to obtain the light source color value of the first virtual visible light source at each pixel.

In operation 1024, when the pixel is located within illumination coverage of at least two first virtual visible light sources, a first target color value of the pixel is determined based on light source color values of the at least two first virtual visible light sources at the pixel.

In some aspects, when the pixel is located within the illumination coverage of the at least two first virtual visible light sources, it indicates that the at least two first virtual visible light sources have impact on a color of the pixel. Therefore, an initial pixel value of the pixel and the light source color values of the at least two first virtual visible light sources that have impact on the pixel at the pixel are added up to obtain the first target color value of the pixel.

For the first virtual visible light source whose screen-to-body ratio is less than the screen-to-body ratio threshold, a drawing command of the light source may be packaged in a manner of GPU Driven, a DrawIndirect command is invoked, and batch drawing is performed through the foregoing operations 1021 to 1024. In this way, all the first virtual visible light sources having small areas may be drawn by invoking a GPU Drive command once, so that a light source data amount for light source rendering by using a light source list can be reduced, thereby improving the rendering efficiency.

Still refer to FIG. 3A. The following is described continuing with operation 102.

In operation 103, a light source list of each screen tile is determined.

The light source list includes only a second virtual visible light source whose screen-to-body ratio is greater than or equal to the screen-to-body ratio threshold.

In some aspects, because there are a large quantity of real-time discrete point light sources or spotlights in the virtual scene, the light sources affect only a small region. During rendering, not all the light sources in the scene need to be considered, and only some light sources need to be considered, because an item is affected by only some light sources. Based on this, the screen may be divided into a plurality of screen tiles according to a preset size, and the light source list of each screen tile is determined. The light source list includes light sources that have impact on the screen tile. For example, the screen may be divided into a plurality of screen tiles having a size of 16*16, or may be divided into screen tiles having a size of 32*32. The size of the screen tile may be adjusted according to an actual requirement. If an impact range of the light source is large, the screen may be divided into large screen tiles. If an impact range of the light source is small, the screen may be divided into small screen tiles. In this aspect described herein, because the second virtual visible light source is a virtual visible light source whose screen-to-body ratio is greater than the preset screen-to-body ratio threshold, a large screen tile, for example, a screen tile having a size of 32*32, may be used.

In some aspects, refer to FIG. 4B. Operation 103 may be implemented by the following operations 1031 to 1036. Descriptions are provided below with reference to FIG. 4B.

In operation 1031, second position information of the second virtual visible light source in the camera space is determined.

In some aspects, a second absolute position of the second virtual visible light source in the world space is first obtained, and then rigid transformation is performed on the second absolute position by using a rotation matrix and a translation matrix from the world space to the camera space, to obtain second position information of the second virtual visible light source in the camera space.

In operation 1032, a distance between the second virtual visible light source and a tile bounding box of the screen tile is determined, and a light source type of the second virtual visible light source is obtained if the distance is less than a light source radius of the second virtual visible light source.

In some aspects, the screen tile is a plurality of tiles into which a two-dimensional screen is divided according to a preset size. The tile bounding box of the screen tile is a three-dimensional structure constructed according to a preset depth and vertex coordinates of four vertexes of the screen tile. After the screen tile bounding box is determined, a coordinate of a center of the tile bounding box is determined, and then the distance between the second virtual visible light source and the tile bounding box of the screen tile may be determined based on the second position information of the second virtual visible light source and the center coordinate of the tile bounding box. If the distance is less than the light source radius of the second virtual visible light source, it indicates that the second virtual visible light source may affect the screen tile. In this case, the light source type of the second virtual visible light source is obtained. The light source type of the second virtual visible light source may be a point light source type, a spotlight type, or the like. If the distance is greater than or equal to the light source radius of the second virtual visible light source, it indicates that the second virtual visible light source does not affect the screen tile, and therefore, the second virtual visible light source is not added to a light source list corresponding to the screen tile, and then whether another second virtual visible light source needs to be added to the light source list corresponding to the screen tile continues to be determined.

In operation 1033, whether the light source type is the point light source type is determined.

If the light source type is the point light source type, operation 1034 is performed. If the light source type is not the point light source type, operation 1035 is performed.

In operation 1034, the second virtual visible light source is added to the light source list of the screen tile.

In some aspects, if the light source type of the second virtual visible light source is the point light source type, because the point light source is a light source that emits light uniformly from a point to a surrounding space, when the distance between the second virtual visible light source and the tile bounding box of the screen tile is less than the light source radius of the second virtual visible light source, it indicates that the second virtual visible light source affects the screen tile, and the second virtual visible light source is added to the light source list of the screen tile.

In some aspects, the light source list includes at least one light source node, and each light source node stores a current light source identifier and a previous light source identifier; and because each screen tile in a graphics processing unit (GPU) traverses the second virtual visible light source in parallel to determine whether the second virtual visible light source is in the screen tile, each light source node needs one piece of link information (Link), and the link information is configured for representing a previous light source identifier of a current light source in the screen tile. When the second virtual visible light source is the first light source node in the light source list, a light source identifier of the second virtual visible light source is added to a current light source identifier corresponding to the first light source node; a previous light source identifier of the first light source node is determined to be null; when the second virtual visible light source is an N^{th} light source node in the light source list, a light source identifier of the second virtual visible light source is added to a current light source identifier corresponding to the N^{th} light source node; and a current light source identifier corresponding to an (N−1)^{th} light source node is added to a previous light source identifier corresponding to the N^{th} light source node, where N is an integer greater than 1.

As shown in FIG. 4C, a light source 1 is the first light source in a screen tile 1, so that link information (that is, a previous light source identifier) of the light source 1 is null; a light source 4 is the second light source in the screen tile 1, so that link information of the light source 4 is the previous light source identifier, that is, 1; and a light source 5 is the third light source in the screen tile 1, so that link information of the light source 5 is the previous light source identifier, that is, 4; and similarly, a light source 2 is a first light source in a screen tile 2, so that link information of the light source 2 is null; and a light source 3 is a second light source in the screen tile 2, so that link information of the light source 3 is the previous light source identifier, that is, 2.

In operation 1035, a light source direction and a cone angle of the second virtual visible light source are obtained if the light source type is the spotlight type.

In some aspects, if the second light source is the spotlight type, because the light source of the spotlight type is different from the point light source that emits light uniformly into the surrounding space, an illumination range of the light source of the spotlight type is related to a light source direction and a cone angle. Therefore, in this case, the light source direction and the cone angle of the second virtual visible light source need to be obtained. When the light source type is the spotlight type, the light source direction and the cone angle may be obtained from attribute information of the second virtual visible light source. The light source direction and the cone angle are set when the second virtual visible light source is created. The light source direction is configured for representing a direction of light illumination, and the cone angle is configured for controlling a degree of beam diffusion. A larger cone angle indicates a higher degree of beam diffusion.

In operation 1036, the second virtual visible light source is added to the light source list of the screen tile when it is determined, based on the light source direction and the cone angle of the second virtual visible light source, that the tile bounding box is within coverage of the second virtual visible light source.

In some aspects, after the light source direction and the cone angle of the second virtual visible light source are obtained, a light source intensity and an attenuation coefficient of the second virtual visible light source are obtained, and an attenuation formula of the second virtual visible light source is obtained. Distance information corresponding to attenuation of illumination intensity to a preset attenuation value is determined based on the attenuation formula, the light source intensity, and the attenuation coefficient of the second virtual visible light source, so as to determine the coverage of the second virtual visible light source based on the second position information, the light source direction, the cone angle of the second virtual visible light source, and the distance information. Whether the tile bounding box is within the coverage of the second virtual visible light source is then determined. If it is determined that the tile bounding box is within the coverage of the second virtual visible light source, it indicates that the second virtual visible light source affects the screen tile. Therefore, the second virtual visible light source is added to the light source list corresponding to the screen tile.

Through the foregoing operations 1031 to 1036, after the second position information of the second virtual visible light source in the camera space is determined, when it is determined that the second virtual visible light source may affect a pixel in the screen tile, whether to add the second virtual visible light source to the light source list corresponding to the screen tile is further determined according to the light source type of the second virtual visible light source, thereby ensuring that all the second virtual visible light sources that are stored in the light source list affect the screen tile, and ensuring accuracy of a rendering result.

Still refer to FIG. 3A. The following is described continuing with operation 103.

In operation 104, full-screen drawing is performed based on the light source list of each screen tile, to obtain a second drawing result.

In some aspects, the full-screen drawing refers to drawing all screen tiles of an entire screen one time. In other words, parallel rendering is performed on a plurality of screen tiles. Refer to FIG. 5. The following operations 1041 to 1043 are performed for each to-be-rendered pixel, to perform full-screen drawing on the light source list of each screen tile, to obtain a rendered virtual scene. Descriptions are provided below with reference to FIG. 5.

In operation 1041, a screen tile in which the pixel is located is determined based on a position of the pixel, and a light source list corresponding to the screen tile is obtained.

In some aspects, because the screen tile is obtained by dividing the screen according to a preset size, the screen tile in which the pixel is located may be determined according to the preset size and the position of the pixel. Therefore, after the position of the pixel is known, it is assumed that a coordinate of the known pixel is (x₁, y₁), and

$$⌈ \frac{{x}_{1}}{n} ⌉$$

is determined as a quantity of rows corresponding to the screen tile in which the pixel is located, and

$$⌈ \frac{{y}_{1}}{n} ⌉$$

is determined as a quantity of columns corresponding to the screen tile in which the pixel is located, where [k] represents rounding up on k. In this way, when the quantity of rows and the quantity of columns corresponding to the screen tile are determined, that is, the screen tile in which the pixel is located can be determined, and in this case, the light source list corresponding to the screen tile is obtained.

In operation 1042, a light source color value of each second virtual visible light source at the pixel is determined according to a light source type of each second virtual visible light source in the light source list.

In some aspects, an attenuation formula of each second virtual visible light source is obtained according to the light source type of each second virtual visible light source in the light source list, a light source intensity and an attenuation coefficient of each second virtual visible light source are obtained, and then a distance between the second virtual visible light source and each pixel in the screen tile is determined, so that an illumination intensity of the second virtual visible light source at the pixel is determined based on the attenuation formula, the light source intensity, and the attenuation coefficient of the second virtual visible light source, and the calculated distance, then an initial light source color value of the second virtual visible light source is obtained, and a product of the illumination intensity of the second virtual visible light source at the pixel point and the initial light source color value is determined as a pixel value of the second virtual visible light source at the pixel.

In operation 1043, a second target color value of the pixel is determined based on the light source color value of each second virtual visible light source at the pixel.

In some aspects, because a pixel in a screen tile is affected by each second virtual visible light source in the light source list corresponding to the screen tile, an initial pixel value of the pixel and the light source color value of each second virtual visible light source in the light source list at the pixel need to be added up, to obtain the second target color value of the pixel.

In operation 105, the first drawing result is merged with the second drawing result, to obtain a drawn virtual scene, and the virtual scene is displayed.

In some aspects, the first drawing result is obtained by performing batch drawing on the first virtual visible light source whose screen-to-body ratio is less than the preset screen-to-body ratio threshold. The first drawing result includes a first target color value of each pixel within an illumination range of the first virtual visible light source. The first drawing result may further include a first target color value of each pixel outside the illumination range of the first virtual visible light source. The first target color value is the initial pixel value of each pixel. The second drawing result is obtained by performing full-screen drawing based on the light source list including only the second virtual light source whose screen-to-body ratio is greater than or equal to the screen-to-body ratio threshold, and the second drawing result includes the second target color value of each pixel. Therefore, in this operation, the first drawing result is merged with the second drawing result, that is, the first target color value of each pixel in the first drawing result and the second target color value of each pixel at a corresponding position in the second drawing result are superimposed, to obtain a third target pixel value of each pixel, thereby obtaining a complete drawn virtual scene, and displaying the virtual scene.

In the rendering method provided in the aspects described herein, after the to-be-rendered virtual scene data is obtained, the plurality of virtual visible light sources in the virtual scene is first determined based on the virtual scene data, and the screen-to-body ratio of each virtual visible light source is determined. Then, for the first virtual visible light source whose screen-to-body ratio is less than the preset screen-to-body ratio threshold, the batch drawing is performed on the plurality of first virtual visible light sources by invoking the batch rendering drawing command. For the second virtual visible light source whose screen-to-body ratio is greater than or equal to the screen-to-body ratio threshold, the light source list of each screen tile is determined, and the light source list includes only the second virtual visible light source. Then, the full-screen drawing is performed based on the light source list of each screen tile, and the drawing results obtained through drawing twice are merged, to obtain the rendered virtual scene. In other words, in the aspects described herein, the solution of combining the batch drawing and the tiled rendering is used, drawing of all of the large quantity of light sources whose screen-to-body ratios are less than the screen-to-body ratio threshold is completed by invoking the batch drawing command once, thereby greatly reducing the calculation amount of the tiled rendering. Therefore, the large quantity of light sources in the virtual scene can be rapidly rendered, thereby improving the rendering efficiency.

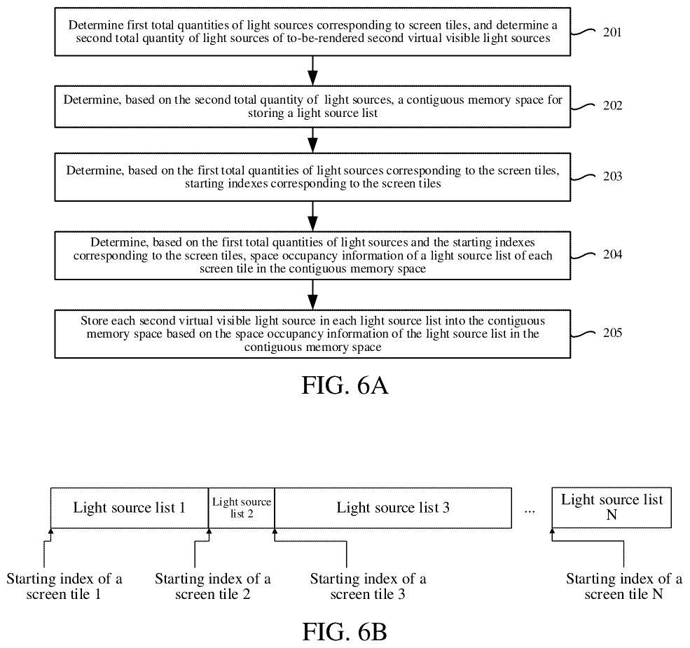

In some aspects, after operation 1036, operations 201 to 205 shown in FIG. 6A may further be performed, so as to perform compressed storage on the light source list of the screen tile. Descriptions are provided below with reference to FIG. 6A.

In operation 201, first total quantities of light sources corresponding to the screen tiles are determined, and a second total quantity of light sources of to-be-rendered second virtual visible light sources is determined.

In some aspects, because each light source node in the light source list stores a current light source identifier and a previous light source identifier, reverse traversal may be performed on a light source list corresponding to each screen tile, to obtain the first total quantities of light sources corresponding to the screen tiles. The first total quantity of light sources is a total quantity of second virtual visible light sources included in the light source list corresponding to each screen tile. Then, the first total quantities of light sources corresponding to the screen tiles are summed, to obtain the second total quantity of light sources of the to-be-rendered second virtual visible light sources.

In operation 202, a contiguous memory space for storing the light source list is determined based on the second total quantity of light sources.

In some aspects, a size of a memory space that needs to be occupied by each light source node in the light source list is first obtained, then a product of the second total quantity of light sources and the size of the memory space occupied by each light source node is determined as a size of a total memory space required for storing the light source lists of all the screen tiles, and finally, a contiguous memory space corresponding to the size of the total memory space is obtained from a memory. Determining the contiguous memory space is determining a starting address and an ending address of the contiguous memory space.

In operation 203, a starting index corresponding to each screen tile is determined based on the first total quantities of light sources corresponding to the screen tiles.

In some aspects, the starting index corresponding to the screen tile is a starting index of the light source list corresponding to the screen tile in the contiguous memory space. A starting index corresponding to the first screen tile is 0, a starting index corresponding to the second screen tile is a first total quantity of light sources corresponding to the first screen tile, a starting index corresponding to the third screen tile is a sum of the first total quantity of light sources corresponding to the first screen tile and a first total quantity of light sources corresponding to the second screen tile, and so on. A starting index corresponding to an i^{th} screen tile is a sum of the total quantities of the first light sources corresponding to first (i−1) screen tiles, where i is an integer greater than 1.

For example, it is assumed that the first total quantity of light sources corresponding to the first screen tile is 20, the first total quantity of light sources corresponding to the second screen tile is 30, and a first total quantity of light sources corresponding to the third screen tile is 20, the starting index corresponding to the first screen tile is 0, the starting index corresponding to the second screen tile is 20, the starting index corresponding to the third screen tile is 20+30=50, and a starting index corresponding to a fourth screen tile is 20+30+20=70.

In operation 204, spatial occupancy information of the light source list corresponding to each screen tile in the contiguous memory space is determined based on the first total quantities of light sources and the starting indexes corresponding to the screen tiles.

In some aspects, the spatial occupancy information of the light source list in the contiguous memory space includes a starting storage address of the light source list in the contiguous memory space. The spatial occupancy information may further include an ending storage address of the light source list in the contiguous memory space. Because the size of the memory space occupied by each light source node, the starting index corresponding to each screen tile, and the starting address of the contiguous memory space are known, the starting storage address of the light source list corresponding to the screen tile in the contiguous memory space is obtained by multiplying the starting address of the contiguous memory space and the size of the memory space occupied by each light source node by the starting index corresponding to each screen tile.

In operation 205, each second virtual visible light source in each light source list is stored into the contiguous memory space based on the spatial occupancy information of the light source list in the contiguous memory space.

In some aspects, a light source identifier of each second virtual visible light source in each light source list and a light source identifier of a previous second virtual visible light source may be sequentially stored into the contiguous memory space based on the starting storage address included in the spatial occupancy information of the light source list in the contiguous memory space.

FIG. 6B is another schematic diagram of performing compressed storage on a light source list according to an aspect described herein. As shown in FIG. 6B, after the starting index of each screen tile is determined, the light source list corresponding to each screen tile is stored into the contiguous memory space based on the starting index of each screen tile, thereby implementing compressed storage of the light source list and improving utilization of the memory space.

Through the foregoing operations 201 to 205, the light source list of each screen tile is stored in a contiguous memory space. In this way, the utilization of the memory space can be improved, and when the light source list of each screen tile is obtained, the light source list may be sequentially read from the contiguous memory space, which can reduce time consumed for data reading, thereby improving the rendering efficiency.

The following describes an illustrative application of this aspect described herein in an actual application scenario.

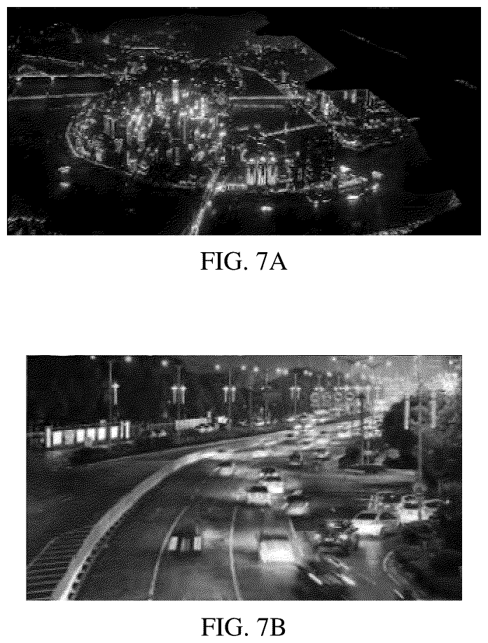

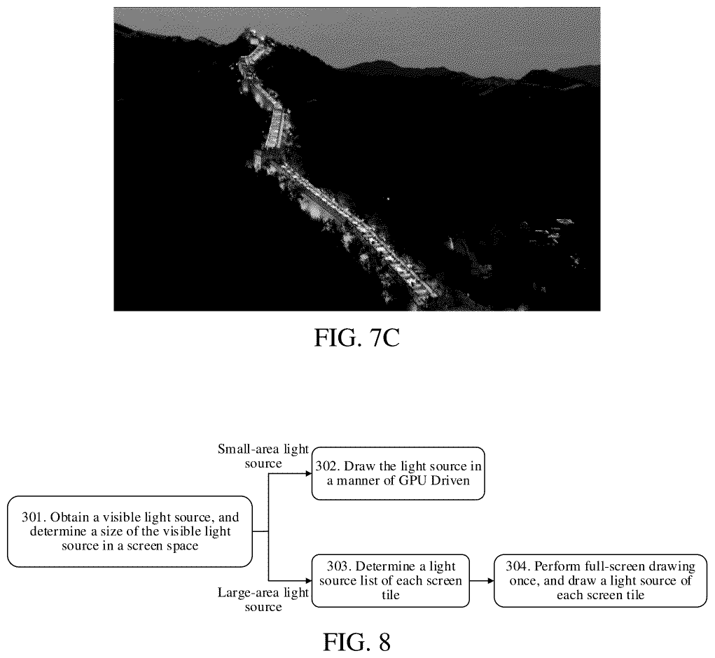

The rendering method provided in the aspects described herein is mainly applied to a scene in which a large-scale dynamic light source needs to be rendered in real time, such as a video game, virtual reality, a building design, or an animated film. When a virtual scene data representation is that an airplane flies above a city at night, a light effect of a city night view from an airplane shown in FIG. 7A can be obtained through rendering by using the rendering method provided in this aspect described herein. When the virtual scene data representation is that a vehicle is traveling on a road of a city at night, a dynamic light and shadow effect of a vehicle traveling on a road shown in FIG. 7B can be obtained through rendering by using the rendering method provided in this aspect described herein. When the virtual scene data representation is that the Great Wall is lit up at night, a night-scene light effect of a digital Great Wall shown in FIG. 7C can be obtained through rendering by using the rendering method provided in this aspect described herein.

FIG. 8 is a schematic flowchart of another implementation of a rendering method according to an aspect described herein. The rendering method provided in this aspect described herein is described below with reference to FIG. 8.

In operation 301, a visible light source is obtained, and a size of the visible light source in a screen space is determined.

In some aspects, to-be-rendered virtual scene data is first obtained, and a plurality of light sources included in the to-be-rendered virtual scene data is determined. Then, frustum culling and occlusion culling are performed on the plurality of light sources in a GPU, a visible light source in a virtual scene is selected, and the size of the visible light source in the screen space is calculated.

In operation 302, for a small-area light source, the light source is drawn in a manner of GPU Driven.

The small-area light source is a light source whose screen-to-body ratio is less than a screen-to-body ratio threshold. In some aspects, a drawing command of the light source may be packaged in the manner of GPU Driven, and an indirect drawing (DrawIndirect) command is invoked, to perform batch drawing on a plurality of small-area light sources. During implementation, a conventional manner of drawing coverage by using a template test may be not used, but illumination coverage of each small-area light source is directly calculated by using light source attenuation and an angle. After the illumination coverage of the small-area light source is determined, a drawn color value of each pixel within the illumination coverage is determined based on a light source attenuation coefficient, a light source color, and a light source intensity of each small-area light source.

In operation 303, for a large-area light source, a light source list of each screen tile is determined.

The light source list includes only the large-area light source. The large-area light source is a light source whose screen-to-body ratio is greater than or equal to the screen-to-body ratio threshold. In some aspects, for a large-area light source nearby, the light source list of each screen tile may be calculated in a tile-based manner. During implementation, for each screen tile, all the large-area light sources are traversed, a position of the large-area light source in a camera space is calculated, and then a distance between the large-area light source and a tile bounding box of each screen tile is determined based on the position of the large-area light source in the camera space. If the distance is less than a radius of the large-area light source, it is considered that the large-area light source affects the screen tile. If a light source type of the large-area light source is a point light source, the large-area light source is directly added to the light source list of the screen tile. If the light source type of the large-area light source is a spotlight, whether the tile bounding box is within an illumination range of the spotlight is determined according to a light source direction and a cone angle of the spotlight; and if the tile bounding box is within the illumination range of the spotlight, the large-area light source is added to the light source list of the screen tile.

In some aspects, an ID of a current light source and a link of a previous light source node are recorded in the light source list. After the light source list of each screen tile is determined, a structure of the light source list of each screen tile is compressed. First, the light source list is traversed backward to calculate a quantity of light sources in the screen tile; the quantity of light sources in the screen tile and a starting index corresponding to the light source list are stored; then, a storage range of the light source list in a contiguous memory structure is determined based on data of the light sources in the screen tile and the starting index corresponding to the light source list; and finally, all the light sources in the screen tile are recorded into the contiguous memory structure corresponding to the storage range.

In operation 304, full-screen drawing is performed once, to draw a light source of each screen tile.

In some aspects, for each pixel, a screen tile in which the pixel is located is calculated, a light source list of the screen tile is obtained, then the light source list is traversed, diffuse reflection and a highlight color value on the position are calculated according to a type of the light source, all the color values in the light source list are superimposed to obtain a second target color value of the pixel, and finally the second target color value of the pixel is outputted.

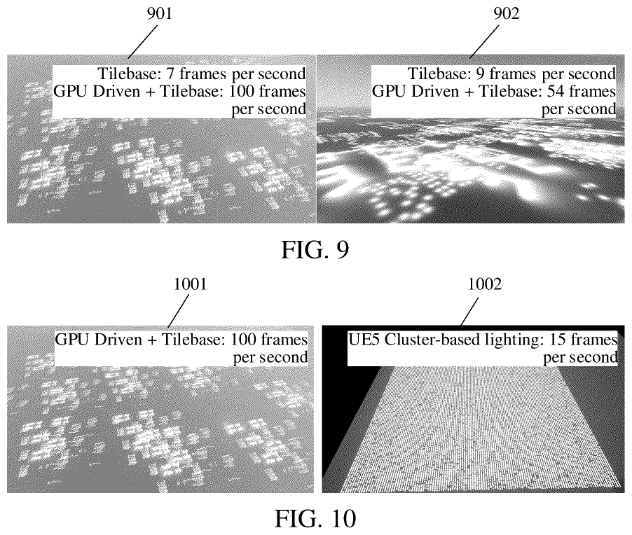

FIG. 9 is a schematic diagram of an effect of performing long-distance light source rendering and short-distance light source rendering by using a rendering method according to an aspect described herein. Compared with a tile-based lighting algorithm in the related art, in a performance test of a scene with 50,000 light sources, in a case that the rendering method provided in this aspect described herein is in combination with GPU Driven and Tilebase, as shown by 901 in FIG. 9, when the long-distance light source rendering is performed, a frame rate can be improved from 7 frames to 100 frames; and in a case that a short-distance overdraw is worsened, consumption of tile culling can be reduced due to effects of light source division and early culling, as shown by 902 in FIG. 9, the frame rate can also be improved from 9 frames to 54 frames.

FIG. 10 is a diagram of a comparison effect between a rendering method according to an aspect described herein and a cluster-based lighting algorithm in the related art. When a quantity of light sources reaches a level of 50,000, as shown by 1001 in FIG. 10, in a case that the rendering method provided in this aspect described herein is in combination with GPU Driven and Tilebase, a frame rate can reach 100 frames per second. Because overheads of constructing a complex cluster light list are excessively large, as shown by 1002 in FIG. 10, a frame rate of the cluster-based lighting algorithm may be significantly reduced to 15 frames per second.

An aspect described herein provides a rendering solution based on a combination of GPU Driven and tiled rendering. By combining advantages of the GPU Driven and the tiled rendering, a large quantity of light sources in a scene are rendered rapidly. There is almost no consumption of central processing unit (CPU) overheads and CPU synchronization in the whole process. Meanwhile, because one CPU draw completes drawing of a large quantity of light sources in all medium and long-range scenes, a GBuffer cache hit rate is greatly improved, thereby avoiding bandwidth consumption during a plurality of times of drawing.

In the aspects described herein, relevant data such as virtual scene data is involved. When the aspects described herein are applied to specific products or technologies, user permission or consent is required, and collection, use, and processing of the relevant data need to comply with relevant laws, regulations, and standards of relevant countries and regions.

The following continues to describe an illustrative structure in which implementation of a rendering apparatus 455 provided in the aspects described herein is a software module. In some aspects, as shown in FIG. 2, the software module in the rendering apparatus 455 stored in a memory 450 may include:
a first determining module 4551, configured to obtain to-be-rendered virtual scene data, determine a plurality of virtual visible light sources in a virtual scene based on the virtual scene data, and determine a screen-to-body ratio of each virtual visible light source; a first rendering module 4552, configured to perform batch rendering drawing on a first virtual visible light source whose screen-to-body ratio is less than a preset screen-to-body ratio threshold and that is in the plurality of virtual visible light sources; a second determining module 4553, configured to determine a light source list of each screen tile, where the light source list includes only a second virtual visible light source whose screen-to-body ratio is greater than or equal to the screen-to-body ratio threshold; a second rendering module 4554, configured to perform full-screen drawing based on the light source list of each screen tile, to obtain a second drawing result; and a display module 4555, configured to: merge a first drawing result with the second drawing result, to obtain a drawn virtual scene, and display the virtual scene.

In some aspects, the first determining module 4551 is further configured to: determine, based on the virtual scene data, a plurality of virtual light sources existing in the virtual scene; and perform frustum culling and occlusion culling on the plurality of virtual light sources, to obtain the plurality of virtual visible light sources in the virtual scene.

In some aspects, the first determining module 4551 is further configured to: obtain a spherical center coordinate of a bounding sphere and a radius of the bounding sphere of the virtual visible light source in a camera space; obtain a projection matrix from the camera space to a screen space, and determine a scaling ratio based on the projection matrix; determine first size information of the virtual visible light source in the camera space by using the scaling ratio, the radius of the bounding sphere, and the spherical center coordinate; and obtain second size information of a screen presenting the virtual scene, and determine the screen-to-body ratio of the virtual visible light source based on the first size information and the second size information.

In some aspects, the first rendering module 4552 is further configured to: obtain first position information of the first virtual visible light source in the camera space, and a light source attenuation coefficient, a light source intensity, and an illumination angle of the first virtual visible light source; determine illumination coverage of the first virtual visible light source based on the first position information, the light source attenuation coefficient, the light source intensity, and the illumination angle; determine a light source color value of the first virtual visible light source at each pixel located within the illumination coverage; and determine, when the pixel is located within illumination coverage of at least two first virtual visible light sources, a first target color value of the pixel based on light source color values of the at least two first virtual visible light sources at the pixel.

In some aspects, the second determining module 4553 is further configured to: determine second position information of the second virtual visible light source in the camera space; determine a distance between the second virtual visible light source and a tile bounding box of the screen tile, and obtain a light source type of the second virtual visible light source if the distance is less than a light source radius of the second virtual visible light source; and add the second virtual visible light source to the light source list of the screen tile if the light source type is a point light source.

In some aspects, the second determining module 4553 is further configured to: obtain a light source direction and a cone angle of the second virtual visible light source if the light source type is a spotlight type; and add the second virtual visible light source to the light source list of the screen tile when it is determined, based on the light source direction and the cone angle of the second virtual visible light source, that the tile bounding box is within coverage of the second virtual visible light source.

In some aspects, the light source list includes at least one light source node, and each light source node stores a current light source identifier and a previous light source identifier of the current light source identifier; and the second determining module 4553 is further configured to: add, when the second virtual visible light source is a first light source node in the light source list, a light source identifier of the second virtual visible light source to a current light source identifier corresponding to the first light source node; determine that a previous light source identifier of the first light source node is null; add, when the second virtual visible light source is an N^{th} light source node in the light source list, the light source identifier of the second virtual visible light source to a current light source identifier corresponding to the N^{th} light source node; and add a current light source identifier corresponding to an (N−1)^{th} light source node to a previous light source identifier corresponding to the N^{th} light source node.

In some aspects, the rendering apparatus further includes: a third determining module, configured to determine first total quantities of light sources corresponding to the screen tiles, and determine a second total quantity of light sources of to-be-rendered second virtual visible light sources; a fourth determining module, configured to determine, based on the second total quantity of light sources, a contiguous memory space for storing the light source list; a fifth determining module, configured to determine, based on the first total quantities of light sources corresponding to the screen tiles, starting indexes corresponding to the screen tiles; a sixth determining module, configured to determine, based on the first total quantities of light sources and the starting indexes corresponding to the screen tiles, spatial occupancy information of the light source list corresponding to each screen tile in the contiguous memory space; and a storage module, configured to store the second virtual visible light source in each light source list into the contiguous memory space based on the spatial occupancy information of the light source list in the contiguous memory space.

In some aspects, the second rendering module 4554 is further configured to: perform the following operations on each to-be-rendered pixel: determining, based on a position of the pixel, a screen tile in which the pixel is located, and obtaining a light source list corresponding to the screen tile; determining a light source color value of each second virtual visible light source at the pixel according to a light source type of each second virtual visible light source in the light source list; and determining a second target color value of the pixel based on the light source color value of each second virtual visible light source at the pixel.

In some aspects, the display module 4555 is further configured to: obtain a first target color value of each pixel from the first drawing result, and obtain a second target color value of each pixel from the second drawing result; superimpose, for each pixel, the first target color value and the second target color value of the pixel, to obtain a third target color value of the pixel; and draw the virtual scene by using the third target color value of each pixel.

An aspect described herein provides a computer program product. The computer program product includes a computer program or computer-executable instructions, and the computer program or the computer-executable instructions are stored in a computer-readable storage medium. A processor of an electronic device reads the computer-executable instructions from the computer-readable storage medium, and the processor executes the computer-executable instructions, to cause the electronic device to perform the foregoing rendering method according to the aspects described herein.

An aspect described herein provides a computer-readable storage medium, having computer-executable instructions or a computer program stored therein, the computer-executable instructions or the computer program, when executed by a processor, causing the processor to perform the rendering method provided in the aspects described herein, for example, the rendering method shown in FIG. 3A and FIG. 8.

In some aspects, the computer-readable storage medium may be a memory such as a random access memory (RAM), a read-only memory (ROM), a flash memory, a magnetic surface memory, a compact disc, or a compact disc ROM (CD-ROM), or may be various devices including one of or any combination of the foregoing memories.

In some aspects, the computer-executable instructions may be written in the form of a program, software, a software module, a script, or code and according to a programming language (including a compiled or interpreted language or a declarative or procedural language) in any form, and may be deployed in any form, including an independent program or a module, a component, a subroutine, or another unit suitable for use in a computing environment.

In an example, the computer-executable instructions may, but do not necessarily, correspond to a file in a file system, and may be stored in a part of a file that saves another program or other data, for example, may be stored in one or more scripts in a hypertext markup language (HTML) file, may be stored in a file that is specially used for a program in discussion, or may be stored in a plurality of collaborative files (for example, a file that stores one or more modules, subprograms, or code parts).

In an example, the computer-executable instructions may be deployed to be executed on one electronic device, on a plurality of electronic devices located at one location, or on a plurality of electronic devices distributed at a plurality of locations and interconnected through a communication network.

The foregoing descriptions are only the aspects described herein and are not intended to limit the protection scope described herein. Any modification, equivalent replacement, or improvement made within the spirit and scope described herein fall within the protection scope described herein.

What is claimed is:

1. A computer-implemented illumination rendering method, comprising:
determining a plurality of virtual visible light sources in a virtual scene based on to-be-rendered virtual scene data, and determining a screen-to-body ratio of each virtual visible light source;
performing batch rendering drawing on a first subset of the plurality of virtual visible light sources, to obtain a first drawing result, wherein the screen-to-body ratio of each virtual visible light source in the first subset is less than a preset screen-to-body ratio threshold;
determining a light source list of each of a plurality of screen tiles, each light source list comprising a second subset of the plurality of virtual visible light sources, wherein each virtual visible light source in the second subset has a screen-to-body ratio greater than or equal to the screen-to-body ratio threshold;
performing full-screen drawing based on the light source list of each screen tile, to obtain a second drawing result;
merging the first drawing result with the second drawing result, to obtain a drawn virtual scene; and
outputting the scene for display.

2. The method of claim 1, wherein the determining a plurality of virtual visible light sources in a virtual scene based on to-be-rendered virtual scene data comprises:
determining, based on the virtual scene data, a plurality of virtual light sources existing in the virtual scene; and
performing frustum culling and occlusion culling on the plurality of virtual light sources, to obtain the plurality of virtual visible light sources in the virtual scene.

3. The method of claim 2, wherein the determining the screen-to-body ratio of each virtual visible light source comprises:
obtaining a spherical center coordinate of a bounding sphere and a radius of the bounding sphere of the virtual visible light source in a camera space;
obtaining a projection matrix from a world space to the camera space, and determining a scaling ratio based on the projection matrix;
determining first size information of the virtual visible light source in the camera space by using the scaling ratio, the radius of the bounding sphere, and the spherical center coordinate; and
obtaining second size information of a screen presenting the virtual scene, and determining the screen-to-body ratio of the virtual visible light source based on the first size information and the second size information.

4. The method of claim 1, wherein the performing batch rendering drawing on the first subset of the plurality of virtual visible light sources comprises:
obtaining first position information of each first virtual visible light source in the camera space, and a light source attenuation coefficient and a light source intensity of the first virtual visible light source;
determining illumination coverage of each first virtual visible light source based on the first position information, the light source attenuation coefficient, and the light source intensity;
determining a light source color value of each first virtual visible light source at each pixel located within the illumination coverage; and
determining, when the pixel is located within illumination coverage of at least two first virtual visible light sources, a first target color value of the pixel based on light source color values of the at least two first virtual visible light sources at the pixel.

5. The method of claim 1, wherein the determining the light source list comprises, for each second virtual visible light source:
determining second position information of the second virtual visible light source in the camera space;
determining a distance between the second virtual visible light source and a tile bounding box of the screen tile;
obtaining a light source type of the second virtual visible light source when the distance is less than a light source radius of the second virtual visible light source; and
adding the second virtual visible light source to the light source list of the screen tile when the light source type is a point light source.

6. The method of claim 5, wherein the determining the light source list further comprises:
obtaining a light source direction and a cone angle of the second virtual visible light source when the light source type is a spotlight type; and
adding the second virtual visible light source to the light source list of the screen tile when it is determined, based on the light source direction and the cone angle of the second virtual visible light source, that the tile bounding box is within coverage of the second virtual visible light source.

7. The method of claim 5, wherein the light source list comprises at least one light source node, and each light source node stores a current light source identifier and a previous light source identifier of the current light source identifier; and the adding the second virtual visible light source to the light source list of the screen tile comprises:
adding, when the second virtual visible light source is a first light source node in the light source list, a light source identifier of the second virtual visible light source to a current light source identifier corresponding to the first light source node;
determining that a previous light source identifier of the first light source node is null;
adding, when the second virtual visible light source is an N^{th} light source node in the light source list, the light source identifier of the second virtual visible light source to a current light source identifier corresponding to the N^{th} light source node, N being an integer greater than 1; and
adding a current light source identifier corresponding to an (N−1)^{th} light source node to a previous light source identifier corresponding to the N^{th} light source node.

8. The method of claim 7, wherein the method further comprises:
determining first total quantities of light sources corresponding to the screen tiles, and determining a second total quantity of light sources of to-be-rendered second virtual visible light sources;
determining, based on the second total quantity of light sources, a contiguous memory space for storing the light source list;
determining, based on the first total quantities of light sources corresponding to the screen tiles, starting indexes corresponding to the screen tiles;
determining, based on the first total quantities of light sources and the starting indexes corresponding to the screen tiles, spatial occupancy information of the light source list corresponding to each screen tile in the contiguous memory space; and
storing the second virtual visible light source in each light source list into the contiguous memory space based on the spatial occupancy information of the light source list in the contiguous memory space.

9. The method of claim 1, wherein the performing full-screen drawing comprises, for each to-be-rendered pixel:
determining, based on a position of the pixel, a screen tile in which the pixel is located, and obtaining a light source list corresponding to the screen tile;
determining a light source color value of each second virtual visible light source in the light source list at the pixel according to a light source type of the second virtual visible light source; and
determining a second target color value of the pixel based on the light source color value of each second virtual visible light source at the pixel.

10. The method of claim 1, wherein the merging comprises:
obtaining a first target color value of each pixel from the first drawing result, and obtaining a second target color value of each pixel from the second drawing result;
superimposing, for each pixel, the first target color value and the second target color value of the pixel, to obtain a third target color value of the pixel; and
drawing the virtual scene by using the third target color value of each pixel.

11. One or more non-transitory computer readable media comprising computer readable instructions which, when executed by a processor, configure a data processing system to perform:
determining a plurality of virtual visible light sources in a virtual scene based on to-be-rendered virtual scene data, and determining a screen-to-body ratio of each virtual visible light source;
performing batch rendering drawing on a first subset of the plurality of virtual visible light sources, to obtain a first drawing result, wherein the screen-to-body ratio of each virtual visible light source in the first subset is less than a preset screen-to-body ratio threshold;
determining a light source list of each of a plurality of screen tiles, each light source list comprising a second subset of the plurality of virtual visible light sources, wherein each virtual visible light source in the second subset has a screen-to-body ratio greater than or equal to the screen-to-body ratio threshold;
performing full-screen drawing based on the light source list of each screen tile, to obtain a second drawing result;
merging the first drawing result with the second drawing result, to obtain a drawn virtual scene; and
outputting the scene for display.

12. The computer readable media of claim 11, wherein the determining a plurality of virtual visible light sources in a virtual scene based on to-be-rendered virtual scene data comprises:
determining, based on the virtual scene data, a plurality of virtual light sources existing in the virtual scene; and
performing frustum culling and occlusion culling on the plurality of virtual light sources, to obtain the plurality of virtual visible light sources in the virtual scene.

13. The computer readable media of claim 12, wherein the determining the screen-to-body ratio of each virtual visible light source comprises:
obtaining a spherical center coordinate of a bounding sphere and a radius of the bounding sphere of the virtual visible light source in a camera space;
obtaining a projection matrix from a world space to the camera space, and determining a scaling ratio based on the projection matrix;
determining first size information of the virtual visible light source in the camera space by using the scaling ratio, the radius of the bounding sphere, and the spherical center coordinate; and
obtaining second size information of a screen presenting the virtual scene, and determining the screen-to-body ratio of the virtual visible light source based on the first size information and the second size information.

14. The computer readable media of claim 11, wherein the performing batch rendering drawing on the first subset of the plurality of virtual visible light sources comprises:
obtaining first position information of each first virtual visible light source in the camera space, and a light source attenuation coefficient and a light source intensity of the first virtual visible light source;
determining illumination coverage of each first virtual visible light source based on the first position information, the light source attenuation coefficient, and the light source intensity;
determining a light source color value of each first virtual visible light source at each pixel located within the illumination coverage; and
determining, when the pixel is located within illumination coverage of at least two first virtual visible light sources, a first target color value of the pixel based on light source color values of the at least two first virtual visible light sources at the pixel.

15. The computer readable media of claim 11, wherein the determining the light source list comprises, for each second virtual visible light source:
determining second position information of the second virtual visible light source in the camera space;
determining a distance between the second virtual visible light source and a tile bounding box of the screen tile;
obtaining a light source type of the second virtual visible light source when the distance is less than a light source radius of the second virtual visible light source; and
adding the second virtual visible light source to the light source list of the screen tile when the light source type is a point light source.

16. The computer readable media of claim 15, wherein the determining the light source list further comprises:
obtaining a light source direction and a cone angle of the second virtual visible light source when the light source type is a spotlight type; and
adding the second virtual visible light source to the light source list of the screen tile when it is determined, based on the light source direction and the cone angle of the second virtual visible light source, that the tile bounding box is within coverage of the second virtual visible light source.

17. The computer readable media of claim 15, wherein the light source list comprises at least one light source node, and each light source node stores a current light source identifier and a previous light source identifier of the current light source identifier; and the adding the second virtual visible light source to the light source list of the screen tile comprises:
adding, when the second virtual visible light source is a first light source node in the light source list, a light source identifier of the second virtual visible light source to a current light source identifier corresponding to the first light source node;
determining that a previous light source identifier of the first light source node is null;
adding, when the second virtual visible light source is an N^{th} light source node in the light source list, the light source identifier of the second virtual visible light source to a current light source identifier corresponding to the N^{th} light source node, N being an integer greater than 1; and
adding a current light source identifier corresponding to an (N−1)^{th} light source node to a previous light source identifier corresponding to the N^{th} light source node.

18. The computer readable media of claim 11, wherein the performing full-screen drawing comprises, for each to-be-rendered pixel:
determining, based on a position of the pixel, a screen tile in which the pixel is located, and obtaining a light source list corresponding to the screen tile;
determining a light source color value of each second virtual visible light source in the light source list at the pixel according to a light source type of the second virtual visible light source; and
determining a second target color value of the pixel based on the light source color value of each second virtual visible light source at the pixel.

19. The computer readable media of claim 11, wherein the merging comprises:
obtaining a first target color value of each pixel from the first drawing result, and obtaining a second target color value of each pixel from the second drawing result;
superimposing, for each pixel, the first target color value and the second target color value of the pixel, to obtain a third target color value of the pixel; and
drawing the virtual scene by using the third target color value of each pixel.

20. A system, comprising a processor and memory storing computer readable instructions which, when executed by the processor, configure the system to perform:
determining a plurality of virtual visible light sources in a virtual scene based on to-be-rendered virtual scene data, and determining a screen-to-body ratio of each virtual visible light source;
performing batch rendering drawing on a first subset of the plurality of virtual visible light sources, to obtain a first drawing result, wherein the screen-to-body ratio of each virtual visible light source in the first subset is less than a preset screen-to-body ratio threshold;
determining a light source list of each of a plurality of screen tiles, each light source list comprising a second subset of the plurality of virtual visible light sources, wherein each virtual visible light source in the second subset has a screen-to-body ratio greater than or equal to the screen-to-body ratio threshold;
performing full-screen drawing based on the light source list of each screen tile, to obtain a second drawing result;
merging the first drawing result with the second drawing result, to obtain a drawn virtual scene; and
outputting the scene for display.
